(19) United States
(12) Patent Application Publication
(10) Pub. No.: US 2013/0246279 A1
(43) Pub. Date: Sep. 19, 2013

(54) EXTERNAL LOG STORAGE IN AN ASSET STORAGE AND TRANSFER SYSTEM

(71) Applicant: ROYAL CANADIAN MINT/MONNAIE ROYALE CANADIENNE, Ottawa (CA)

(72) Inventor: David EVERETT, Rustington (GB)

(73) Assignee: ROYAL CANADIAN MINT/MONNAIE ROYALE CANADIENNE, Ottawa (CA)

(21) Appl. No.: 13/846,032

(22) Filed: Mar. 18, 2013

Related U.S. Application Data
(60) Provisional application No. 61/612,783, filed on Mar. 19, 2012.

(51) Int. Cl. G06Q 20/38

(52) U.S. Cl. CPC G06Q 20/3827
USPC 705/64

(57) ABSTRACT

A secure asset storage media. A secure module includes a memory storing at least a DuplicateCounter and a HashLog, the HashLog comprising a respective hash of each value transfer message sent or received by the secure asset storage media, the DuplicateCounter storing a count of duplicate hash values in the HashLog. A non-volatile memory is disposed external to the secure module. The non-volatile memory stores a transaction log comprising a copy of each value transfer message sent or received by the secure asset storage media and its respective hash value. A controller is configured to control communication between the secure module and the non-volatile memory to record information of a received value transfer message in the secure module and the transaction log.

### CROSS-REFERENCE TO RELATED APPLICATIONS

This application is based on, and claims benefit of, provisional U.S. patent Application No. 61/612,783 filed Mar. 19, 2012, the entire content of which is hereby incorporated herein by reference.

### TECHNICAL FIELD

The present invention relates to a system for making payments by securely moving assets between the stores held by the participants in the system, and in particular to methods and systems utilizing an external log storage in an asset storage and transfer system.

### BACKGROUND

Referring to FIGS. 1a and 1b, an asset storage and transfer system 2 in accordance with Applicant's PCT patent publications Nos. WO 2011/032257 and WO 2011/032271, the entire content of both publications is hereby incorporated herein by reference, comprises at least two storage media 4 configured to exchange messages through a communications medium 6. Each storage media 4 comprises an input/output (I/O) interface 8 configured to enable the storage media 4 to send and receive messages through the communications medium 6; a controller 10 responsive to received messages to record transfers of content to the storage media 4 and to transfer content from the storage media 4; and a memory 12 storing a respective unique identifier 14 of the storage media 4, a private key 16 and a certificate 18 uniquely assigned to the storage media 4, a log 20 of content transfers to and from the storage media 4, and a current content (Cur.Val) 22 of the storage media.

The private key 16 and a certificate 18, facilitate encryption and digital signature functionality using, for example, well-known Public Key Infrastructure (PKI) techniques. For the purpose, the private key 16 and the certificate 18 will typically be generated by a trusted Issuing Authority, such as, for example, Verisign™.

It is anticipated that the storage media 4 may be constructed as a physical device suitable for distribution and use by an individual person. Multiple such devices may be used by a merchant, for example. The storage media 4 may be configured to connect to a user's communications device 24 for communications through a data network 26, as shown in FIG. 1b. Such a personalized storage media 4 may be manufactured in any suitable form-factor, including, but not limited to, form factors commonly used in smart-cards, USB flash drives or memory cards. The I/O Interface 8 can be provided as any suitable communications link, such as, for example, a Universal Serial Data (USB) or mini-USB connection, a blue-tooth™ or Infra-red wireless connection. Other connection technologies may be used, as desired. Preferably, the I/O interface 8 is designed to enable the user to easily and reliably connect and disconnect their storage media 4 to and from a communications device 24, and, when connected, facilitate secure transfer of information between the storage media 4 and the communication device. For this reason, in embodiments in which a wireless interface technology is used, it is preferable that the wireless connection be operative over a very limited distance (e.g. on the order of 10 cm or less), so as to reduce power requirements and enhance security. Various known radio-frequency electromagnetic or magnetic coupling techniques may be used to implement a wireless connection at this distance.

The communication device 24 may take any suitable form, including, but not limited to, Personal Computers (PCs), note-book PCs, Personal Digital Assistants (PDAs), cell phones, point-of-sale machines etc.

The controller 10 and memory 12 may, for example, be constructed as a secure module 30 using known Subscriber Identity Module (SIM) techniques. However, this is not essential. Preferably, the storage media 4 is configured in such a manner that the controller 10 and memory 12 cannot be removed from the storage media 4 without destroying the controller 10 and memory 12. Use of SIM technology for construction of the controller 10 and memory 12 is beneficial, in that it enables the ID 14, Private Key 16 and certificate 18 to be permanently stored in the storage media 4 in such a manner that it is never destroyed (without destroying the functionality of the entire token, which is inconvenient to the user, but maintains security) and it is not practical to “hack” or reverse engineer the storage media 4 to discover the Private Key 16 or modify any of the log 20, the current content (Cur.Val) 22 or the operation of the storage media 4. As a result, each user of the system 2 has a good reason to believe that the association between the ID 14, Private Key 16 and Certificate 18 of any given storage media 4 is unique, and cannot be fraudulently duplicated.

As noted above, the log 20 maintains a record of asset transfers into and out of the Storage Media 4. In some embodiments, the information recorded in the log 18 comprises the content of each asset transfer message received or sent by the Storage Media 4. In some embodiments, a digest of each asset transfer message may be recorded in the log 20, rather than the entire content. In some cases, the digest may take the form of a hash computed over at least a portion of the asset transfer message. In principle, recording a hash of received value transfer messages, for example, enables effective detection of duplicate messages while minimizing the amount of memory required to store the log 20. This, in turn, increases the number of transactions that can be stored in the log 20, before the storage media 4 needs to be reset.

A limitation of this approach, however, is that it increases the probability of incorrectly detecting a duplicate transfer message. For example, if the hash length is 16 bits, then there are 2¹⁶=65,536 possible different hash values, and the probability of two valid transfer messages yielding identical hash values (and so being rejected by the storage media 4) is 1/65,536. In some cases this is too high.

Techniques for addressing this limitation are desired.

### SUMMARY

An aspect of the present invention provides a secure asset storage media. A secure module includes a memory storing at least a DuplicateCounter and a HashLog, the HashLog comprising a respective hash of each value transfer message sent or received by the secure asset storage media, the DuplicateCounter storing a count of duplicate hash values in the HashLog. A non-volatile memory is disposed external to the secure module. The non-volatile memory stores a transaction log comprising a copy of each value transfer message sent or received by the secure asset storage media and its respective hash value. A controller is configured to control communication between the secure module and the non-volatile memory to record information of a received value transfer message in the secure module and the transaction log.

### BRIEF DESCRIPTION OF THE DRAWINGS

Further features and advantages of the present invention will become apparent from the following detailed description, taken in combination with the appended drawings, in which:

FIGS. 1a and 1b are a block diagrams schematically illustrating an asset storage and transfer system;

FIG. 2 is a block diagram schematically illustrating a storage medium usable in the system of FIGS. 1a and 1b;

FIG. 3 is a flowchart schematically illustrating representative operations of the storage medium of FIG. 2 in a transfer-in process;

FIG. 4 is a block diagram schematically illustrating a merchant environment utilizing the storage medium of FIG. 2;

It will be noted that throughout the appended drawings, like features are identified by like reference numerals.

### DETAILED DESCRIPTION

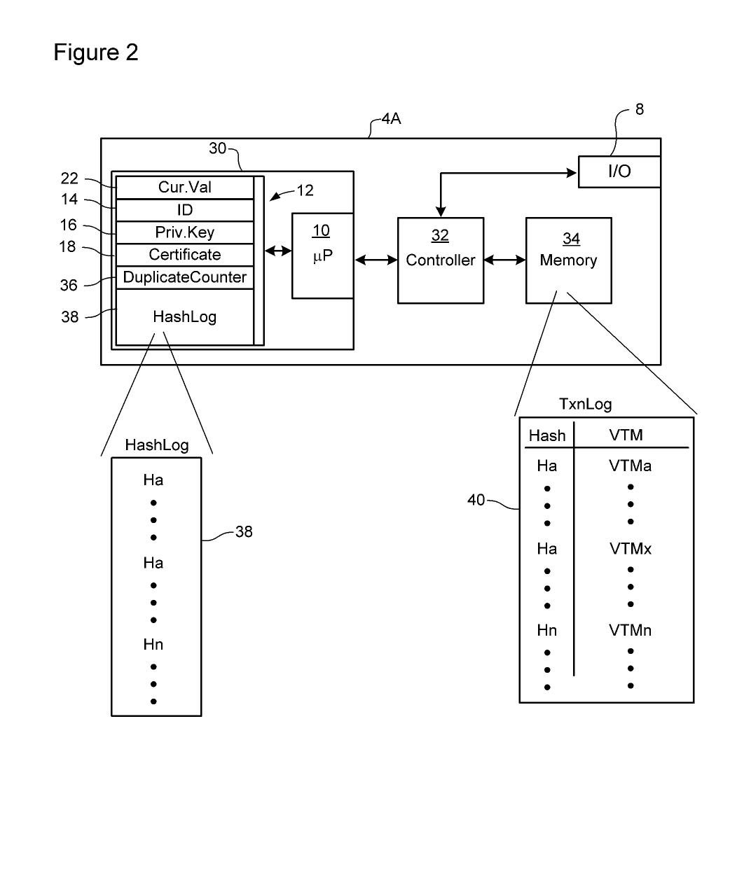

Referring to FIG. 2, a representative asset storage medium 4A is shown which comprises a secure module 30, a controller 32 and an external memory 34.

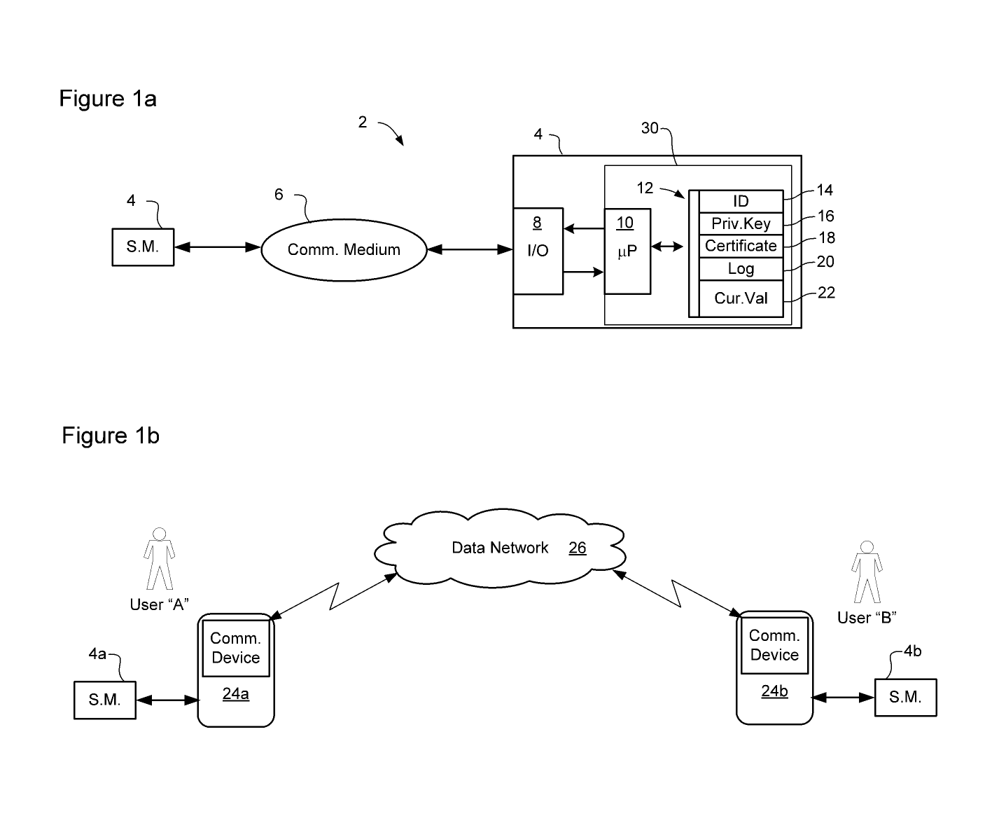

The secure module 30 is closely similar to that described above with reference to FIG. 1a, and in fact differs primarily in the utilization of the memory 12. In particular, the memory 12 is configured to include a duplicate counter 36 and a HashLog 38. The HashLog 38 is used to record a hash of each transfer of asset value into or out of the asset storage medium 40, in a manner closely similar to that described above and in Applicant's PCT patent publications Nos. WO 2011/032257 and WO 2011/032271. If desired, the HashLog 38 may also include a checksum by which the integrity of the HashLog 38 can be verified. For example, as an initial step during both transfer-in and transfer-out processes, the HashLog may use the checksum to check the integrity of the HashLog. If the Integrity check fails, the storage medium 4 may execute a SHUTDOWN procedure to prevent further (improper) operation. The DuplicateCounter 36 is a counter that records the number of duplicate Hash values stored in the HashLog 38. In some embodiments, a respective counter value is stored in the DuplicateCounter 38 for each Hash value stored in the HashLog 38. Prior to use of the asset storage medium 40, or following a reset of the device, the HashLog 38 and the DuplicateCounter 36 are cleared. Thereafter, the DuplicateCounter 36 may be incremented when a valid transfer message is received for which the hash value duplicates a hash value already stored in the hash-Log 38. This operation will be described in greater detail below.

The memory 34 may be configured as a non-volatile Random Access Memory (RAM) such as, for example, a Flash memory. In the illustrated embodiment, the memory 34 is used to store a Transaction log (TxnLog) 40 which contains a complete copy of each value transfer message (set or received) by the asset storage medium 4A, along with its respective hash value. As such, under normal operating conditions the listing of hash values stored in the TxnLog 40 will exactly match the listing stored in the HashLog 38.

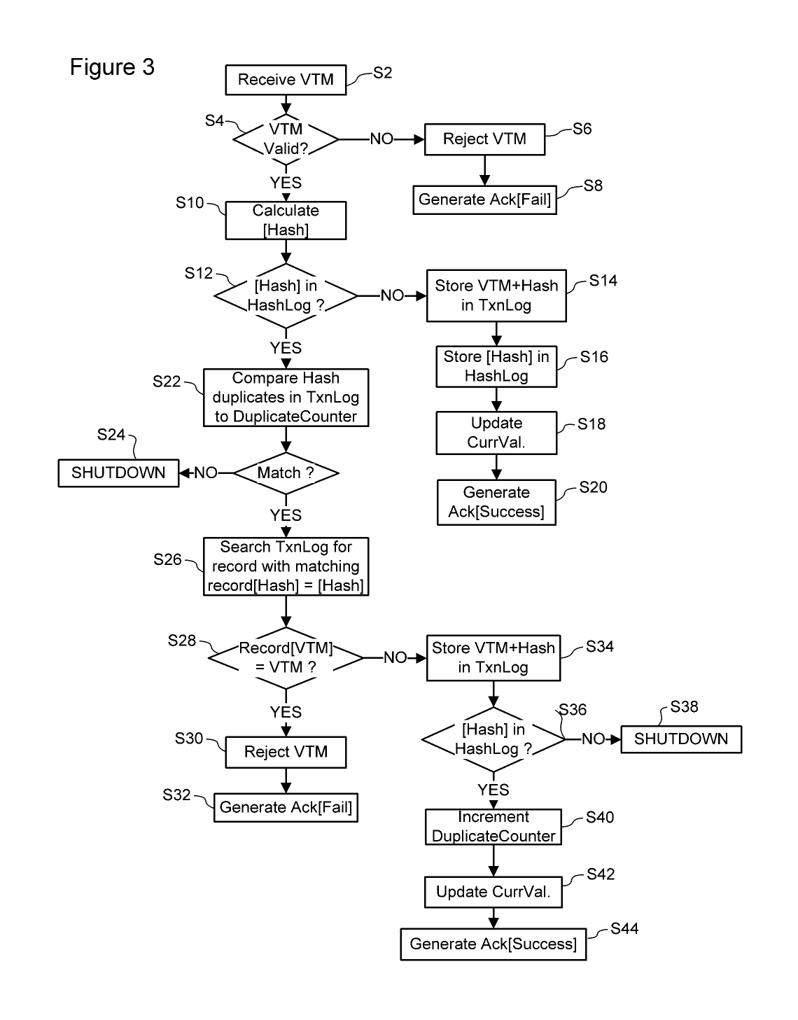

FIG. 3 illustrates principle operations of a representative algorithm that may be executed by the asset storage medium 4A for handling a received value transfer message (VTM). This algorithm may be implemented by any suitable combination of firmware executing on either (or both) of the controller 32 and the processor 10.

When the storage medium 4A receives a VTM (step S2), the VTM is checked for validity (step S4), using methods known, for example from Applicant's PCT patent publications Nos. WO 2011/032257 and WO 2011/032271. Thus, for example, a digital signature of the VTM can be analysed to detect a corrupted VTM. If the VTM fails the validation step, the storage medium 4A rejects the VTM (at S6) and generates a Failure message (at S8). If the VTM is valid, a hash of the VTM is calculated (at S10), and the HashLog 38 checked (at S12) to determine whether or not the calculated hash value as been previously recorded. If the hash value has not been previously recorded, the VTM and hash value are recorded in the TxnLog 40 (at step S14), and the hash value stored in the HashLog 38 (at step S16) to enable future detection of a duplicate VTM. The CurrVal 22 is then updated (at S18) using the asset value of the VTM, and the storage medium 4A generates a “Success” message (at S20) to confirm that the VTM has been successfully received and recorded.

If the calculated hash value is found in the HashLog 38 (at step S12), then the received VTM is a duplicate of a previously received VTM. In this case, the number of duplicate hash values in the TxnLog 40 is compared (at S22) to the value of the DuplicateCounter 36. If the two values do not match, then it is likely that the TxnLog 40 has been corrupted. In this case, the storage medium 4A may execute a SHUTDOWN process (at S24) to prevent further improper operation. On the other hand, if the number of duplicate hash values in the TxnLog 40 matches the value of the DuplicateCounter 36, the TxnLog 40 is searched (at S26) to find a record for which the respective hash value matches the hash value of the newly received VTM. Once found, the recorded VTM and the newly received VTM are compared (at S28). If they match, then it is confirmed that then newly received VTM is a duplicate. In this case, the newly received VTM is rejected (at S30) and a failure message is generated (at S32). On the other hand, if the recorded VTM and the newly received VTM do not match, then the newly received VTM is not, in fact, a duplicate. In this case, the VTM and hash value can be recorded in the TxnLog 40 (at step S34). The HashLog 38 is again checked (at S36) to determine whether or not the hash value is already recorded. Failure to find the hash value in the HashLog 38 indicates improper operation, in which case the storage medium 4A may execute the SHUTDOWN procedure (at S38) to prevent further improper operation. If the hash value is found in the HashLog 38 at step S36, the DuplicateCounter 36 can be incremented (at S40). The CurrVal 22 is then updated (at S42) using the asset value of the VTM, and the storage medium 4A generates a “Success” message (at S44) to confirm that the VTM has been successfully received and recorded.

Important features of the algorithm described above are as follows:
A valid VTM should be accepted, even if its hash value matches a hash value previously recorded in the HashLog 38. This is accomplished by first calculating a hash of the received VTM at step S10, and then comparing the calculated hash to the HashLog 38 at step S12, if a match is not found, then the received VTM can be accepted and the HashLog 38, TxnLog 40 and currVal 22 updated accordingly. On the other hand, if a match is found, then the corresponding record in the TxnLog 40 can be checked at step 26 for a match between the received VTM and the previously received VTM. If a match is found, then the received VTM is a duplicate message and is rejected. On the other hand, if the received VTM does not match the previously received VTM, and if both the received VTM and the previous VTM stored in the TxnLog 40 are valid (determined by checking their respective signatures, for example) then the received VTM is valid and can be accepted and the HashLog 38, TxnLog 40 and currVal 22 updated accordingly. However, in this case, the DuplicateCounter 36 is also incremented (at S40) to reflect the fact that the hash value of the received VTM duplicates that of a previously received VTM.
Attempts to defeat the security of the algorithm or the storage medium 4A by corrupting the TxnLog 40 are detectable. This is accomplished by means of a number of automated checks. For example, if a VTM stored in the TxnLog 40 is corrupted (or modified), this will be detected because either the signature of the stored VTM and/or the corresponding hash value stored in the TxnLog 40 will not match. Similarly, if the number of duplicate hash values stored in the TnxLog 40 does not match the value stored in the DuplicateCounter 36 (eg because a record of a previously received VTM has been deleted from the TxnLog 40), then the TxnLog 40 has been corrupted and the asset storage medium 4A may execute a SHUTDOWN process to prevent further operation.
Security features are based on the information stored in the secure module 30, so that additional security features (such as password protection, encryption etc.) do not need to be provided for the controller 32 of the memory 34.

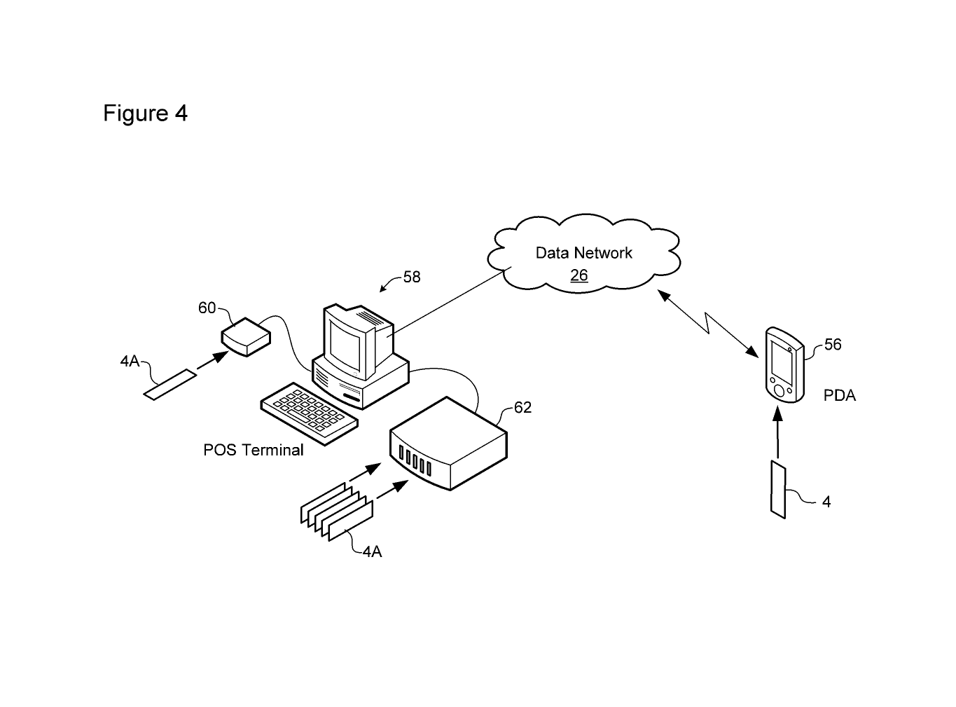

FIG. 4 illustrates a point of sale terminal 58 of a type which may be used by a merchant, for example. Such a system may have a reader 60 configured to enable a user (eg a customer) to connect their storage medium to the POS terminal 58 to facilitate payment for goods received. In the illustrated embodiment, the point of sale terminal 58 is connected to a merchant box 62, which allows the merchant to use a plurality of individual storage media 4A for receiving value transfers (payments) from customers. Because each individual storage media 4A implements secure value transfer messaging with customer's storage media, the merchant box 62 does not need to implement any special security features. Consequently, the use a merchant box 62 provides a merchant with a low-cost way to accept payments from customers using storage media 4A. In some embodiments, either the POS terminal 58 or the merchant box 62 may implement a load-balancing algorithm so as to ensure that each merchant's storage media handle an approximately equal number of transactions.

The embodiment(s) of the invention described above is (are) intended to be exemplary only. The scope of the invention is therefore intended to be limited solely by the scope of the appended claims.

1. A secure asset storage media comprising:
a secure module including a memory storing at least a DuplicateCounter and a HashLog, the HashLog comprising a respective hash of each value transfer message sent or received by the secure asset storage media, the DuplicateCounter storing a count of duplicate hash values in the HashLog;
a non-volatile memory external to the secure module, the non-volatile memory storing a transaction log comprising a copy of each value transfer message sent or received by the secure asset storage media and its respective value; and
a controller configured to control communication between the secure module and the non-volatile memory to record information of a received value transfer message in the secure module and the transaction log.

2. A method of storing asset value, the method comprising:
a secure module storing at least a DuplicateCounter and a HashLog, the HashLog comprising a respective hash of each value transfer message sent or received by the secure asset storage media, the DuplicateCounter storing a count of duplicate hash values in the HashLog;
a non-volatile memory external to the secure module storing a transaction log comprising a copy of each value transfer message sent or received by the secure asset storage media and its respective value; and
a controller controlling communication between the secure module and the non-volatile memory to record information of a received value transfer message in the secure module and the transaction log.

3. The method of claim 2, further comprising executing a SHUTDOWN procedure when a number of duplicate hash values in the transaction log is not equal to a current DuplicateCounter value.

4. The method of claim 2, further comprising:
determining whether a received value transfer message is a duplicate of a previously received value transfer message; and
when the received value transfer message is a duplicate, rejecting the value transfer message.

5. The method of claim 4, wherein determining whether a received value transfer message is a duplicate comprises:
searching the transaction log for to find a record having a respective hash value that matches the hash value of the received value transfer message; and
when a match is found, comparing the value transfer message of the record stored in the transaction log to the received value transfer message.
